(19) United States
(12) Patent Application Publication
(10) Pub. No.: US 2026/0183995 A1
(43) Pub. Date: Jul. 2, 2026

(54) PLASTIC PRODUCT AND METHOD FOR PRODUCING A PLASTIC PRODUCT

(71) Applicant: Ritter GmbH, Schwabmünchen (DE)

(72) Inventors: Roman PREUß, Friedberg (DE); Samuel KREBBER, Königsbrunn (DE); Frank FINIS, Augsburg (DE); Frank NOVAK, Bobingen (DE)

(21) Appl. No.: 19/443,855

(22) Filed: Jan. 8, 2026

Related U.S. Application Data
(63) Continuation of application No. 18/810,864, filed on Aug. 21, 2024.

(30) Foreign Application Priority Data
Aug. 21, 2023 (DE) 102023122330.5

(51) Int. Cl. B29C 45/00; B29K 105/26; B29L 31/00

(52) U.S. Cl. CPC B29C 45/0001; B29C 2795/007; B29K 2105/26; B29L 2031/715; B29L 2031/7678

(57) ABSTRACT

A plastic product, for example a cartridge, is made of plastic material which has a ratio of at least 30 wt.-% of PCR (Post Consumer Recycled) material. A method for producing a plastic product using an injection molding process includes the following steps: (a) providing a partially recycled plastic material comprising a ratio of at least 30 wt.-% of PCR material; (b) liquefying the plastic material; (c) injecting the liquid plastic material into a cavity of a mold; and (d) demolding the product after cooling.

### FIELD

This disclosure relates to systems and methods for plastic products, such as cartridges. More specifically, the disclosed embodiments relate to injection molded plastic products.

### INTRODUCTION

Plastic products are widely used because they are light, cheap to manufacture, robust and therefore practical. Plastic products and plastic packaging are indispensable in various applications, including the storage of chemicals for constructional purposes, such as silicone, acrylic, etc. However, the more plastic containers and packages are used, the greater are the challenges in terms of sustainability. The use of recyclate, such as PCR (Post Consumer Recycled) or PIR (Post Industrial Recycled) material, reduces the problem of a lack of sustainability.

However, recyclates are unsuitable or difficult to handle for many applications. For example, the material properties are not defined due to different types and degrees of contamination in different batches of recyclate. These undefined properties can affect the geometry, e.g. the shrinkage dimensions. In addition, impurities may interact with the filler material of a cartridge as well as with imprints or coatings applied to the outside of the cartridge and impair their effectiveness.

To date, it has not been possible to reliably manufacture plastic cartridges from materials with high proportions of recycled material, for example with proportions of more than 60% by weight of recycled material.

### SUMMARY

The present disclosure provides systems, apparatuses, and methods relating to plastic products.

In some examples, a plastic product comprises a ratio of at least 30% by weight of recycled material, wherein the plastic product has an outer side, with a printed area with a white background arranged on the outer side.

In some examples, a method for manufacturing at least one component of a plastic product in an injection molding process comprises the following steps:
(a) providing (partially) recycled plastic material comprising at least 30% by weight of recycled material;
(b) liquefying the plastic material;
(c) injecting the liquid plastic material into a cavity of a mold; and
(d) demolding the product after cooling;
(e) printing a print field arranged on the outside of the plastic product with a white background; and
(f) directly printing an imprint on the white background of the print field using a direct digital printing method.

Features, functions, and advantages may be achieved independently in various embodiments of the present disclosure, or may be combined in yet other embodiments, further details of which can be seen with reference to the following description and drawings.

### DETAILED DESCRIPTION

In general, the present disclosure describes methods of manufacturing a sustainable plastic product in a recycling process without considerably impairing the product quality.

The present disclosure relates to a plastic product, for example a cartridge, comprising a ratio of at least 30 wt.-%, in particular at least 50 wt-%, in particular at least 60 wt.-%, in particular at least 70 wt-%, in particular at least 80 wt.-%, in particular at least 90 wt.-%, in particular 100 wt.-%, of recycled material, in particular of PCR (Post Consumer Recycled) material.

PCR (Post Consumer Recycled) material is mainly obtained from waste of food packaging, for example PET bottles. PCR (Post Consumer Recycled) material usually contains at least 3-5% wt.-% of residual substances and impurities, respectively. PCR is therefore a plastic that is made from consumer waste. These recycled plastics are referred to as rPET (Recycled Polyethylene Terephthalate), rPP (Recycled Polypropylene Plastic), rHDPE (Recycled High-Density Polythene), etc.

PIR (Post Industrial Recycled) is industrial plastic waste that is generated during production.

The plastic product may be, for example, a cartridge for receiving filling material. However, the present disclosure is not limited to this application, but may be used in any other suitable application.

The plastic product may have a wall which has an outer side and an inner side, whereby a printing field is arranged on the outer side, which is printed directly by means of digital printing.

Printed images produced by means of direct digital printing on (partially) recycled material with a high ratio of recyclate, as in the present invention, could previously not be produced in high quality with a long service life. In particular, if the recyclate is not white but grey or black, color-fast digital printing is not possible; instead, in the prior art a label was used in such situations. However, the applicant has succeeded in digitally printing plastic products made of recyclate material directly. For example, first a white background is printed and the actual printed image is printed on top of the white background. In particular, rotationally symmetrical digital printing, e.g. on the outside of a cartridge, has successfully been carried out as part of the invention.

A method according to the present disclosure for manufacturing a plastic product, in particular a plastic product as described above, by using an injection molding process comprises the following steps:
(a) providing an at least partially recycled plastic material comprising a ratio of at least 30 wt.-%, in particular at least 50 wt-%, in particular at least 60 wt.-%, in particular at least 70 wt-%, in particular at least 80 wt.-%, in particular at least 90 wt.-%, in particular 100 wt.-%, of PCR (Post Consumer Recycled) material;
(b) liquefying the plastic material;
(c) injecting the liquid plastic into a cavity of a mold; and
(d) demolding the product after cooling.

The injection molding equipment may have a mold and a core, both of them delimiting the cavity, and the core may be pulled out of the interior of the plastic product after step (c) and before step (d).

An alternative method for producing at least a component of a plastic product, in particular a plastic product as described above, comprises the following steps:
(a) provision of (partially) recycled plastic material comprising a ratio of at least 30 wt-%-100 wt-% of PCR material,
(b) continuous liquefaction of plastic material,
(c) extruding the plastic material to produce the plastic product or the component of the plastic product.

The ratio of 30%-100% means that any value between and including 30% and 100% may be set as a minimum threshold value of the ratio, particularly any of the threshold values mentioned above (30 wt.-%, 50 wt-%, 60 wt.-%, 70 wt-%, 80 wt.-%, 90 wt.-%, 100 wt.-%).

A further step in any of the above-mentioned methods may be:
(e) direct printing of a printing field of the plastic product by means of digital printing process.

A plastic product as described and/or manufactured above has an outer contour corresponding (or complementary) to an inner contour of a mold, and an inner contour corresponding (or complementary) to an outer contour of a core, wherein the inner contour has a demolding bevel of 0.1° to 15°, in particular of 0.1° to 10°, in particular of 0.1° to 5°, in particular of 0.1° to 1°, in particular of 0.1° to 0.5°.

The printing field may be pre-treated, in particular the printing field may be pre-printed in white. Afterwards, direct printing by means of digital printing on the printing field is conducted, e.g. in a laser or inkjet printing process.

Particularly, but not limited, the plastic product may be a wall and the cylindrical outer wall portion, respectively, of a cartridge (or chamber of a cartridge).

Plastic products according to the invention significantly reduce the product-related CO₂ footprint.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A plastic product comprising at least 30% by weight of recycled material, wherein the plastic product has an outer side, and a printed area having a white background disposed on the outer side.

2. The plastic product according to claim 1, wherein the plastic product comprises at least 50% by weight of recycled material.

3. The plastic product according to claim 1, wherein the plastic product comprises at least 60% by weight of recycled material.

4. The plastic product according to claim 1, wherein the plastic product comprises at least 70% by weight of recycled material.

5. The plastic product according to claim 1, wherein the plastic product comprises at least 80% by weight of recycled material.

6. The plastic product according to claim 1, wherein the plastic product comprises at least 90% by weight of recycled material.

7. The plastic product according to claim 1, wherein the plastic product comprises substantially 100% by weight of recycled material.

8. The plastic product according to claim 1, wherein the plastic product comprises a cartridge.

9. The plastic product according to claim 1, wherein the recycled material contains at least 3-5% by weight of foreign matter.

10. The plastic product according to claim 1, wherein the plastic product comprises a container of a cartridge configured to hold a filling material.

11. The plastic product according to claim 1, wherein the printed area is printed directly using a digital printing method.

12. A method for manufacturing a plastic product in an injection molding process, the method comprising:
(a) providing at least partially recycled plastic material comprising at least 30% by weight of recycled material,
(b) liquefying the plastic material,
(c) injecting the liquid plastic material into a cavity of a mold, and
(d) demolding the product after cooling,
(e) printing a print field on an outside of the plastic product to create a white background; and
(f) directly printing an imprint on the white background of the print field using a direct digital printing method.

13. The method according to claim 12, wherein the imprint is a color imprint.

14. The method according to claim 12, wherein the mold has an outer mold and a core which collectively define the cavity, the method further comprising:
pulling the core out of the interior of the plastic product after step (c) and before step (d).

15. The method of claim 14, wherein the manufactured plastic product comprises an outer contour corresponding to an inner contour of the mold and an inner contour corresponding to a contour of the core, wherein the inner contour has a draft angle of 0.1° to 45°.

16. A method for manufacturing a component of a plastic product, the method comprising:
(a) providing at least partially recycled plastic material comprising 30-100% by weight of recycled material,
(b) continuously liquefying the plastic material,
(c) extruding the plastic material to produce the component,
(d) printing a print area on an outside of the component to create a white background; and
(e) directly printing an imprint on the white background of the print area using direct digital printing.

17. The method according to claim 16, wherein the imprint is a color imprint.
